(19) United States
(12) Patent Application Publication
(10) Pub. No.: US 2022/0234682 A1
(43) Pub. Date: Jul. 28, 2022

(54) DUO-FLEX COMPACT ELECTRICAL PLATFORM FOR MOTORCYCLES

(71) Applicant: SORIANO MOTORI CORP, Massapequa, NY (US)

(72) Inventors: Marco Antonio SORIANO, Massapequa, NY (US); Cesare BRIOSCHI, Oggiono (IT)

(21) Appl. No.: 17/721,056

(22) Filed: Apr. 14, 2022

Related U.S. Application Data
(63) Continuation of application No. PCT/US2021/021517, filed on Mar. 9, 2021.
(60) Provisional application No. 63/028,422, filed on May 21, 2020.

(51) Int. Cl. B62M 11/14; B60L 50/60; B60L 7/10

(52) U.S. Cl. CPC B62M 11/14; B60L 50/66; B62K 2204/00; B60L 2220/42; B60L 7/10

(57) ABSTRACT

A duo-flex compact electrical platform for motorcycles which allows to obtain a mechanical power supply system for electric motorcycles with increased energy efficiency allied to an optimized mechanical power and torque delivery. The proposed platform has two electric motors horizontally arranged within a series of arrangements that also allow to obtain a kinematic solution with self-sufficiency that recharges itself through the use of one of the motors without overloading the other one.

### CROSS-REFERENCE TO RELATED APPLICATIONS

This application is a bypass continuation of PCT/US2021/021517, filed Mar. 9, 2021, which in turn claims the benefit of priority from U.S. Provisional Application No. 63/028,422, filed May 21, 2020, the contents of each of which are incorporated herein by reference.

### TECHNICAL FIELD

The presently disclosed technology describes a duo-flex compact electrical platform for motorcycles.

### BACKGROUND ART

A motorcycle, also referred to as bike, motorbike or cycle, is a two or three wheeled motor vehicle. There are three main categories of motorcycles: street, off-road and dual purpose, each with various sub-categories within them. Each category of motorcycle is designed specifically in consideration of its specialized purpose(s), which results in a wide range of varying embodiments of motorcycles.

Most of presently known technology related to propulsion platforms for electrical motorcycles resort to the use of single electrical motors, associated with huge, oversized and overweighted battery packs, that tend to discourage potential customers interested in moving towards a more environmentally friendly solution with regard to the production and emission of greenhouse gases. Present application discloses a solution that overcomes previous state of the art technologies with regard to overall weight, weight distribution, performance, efficiency, durability and reliability.

### SUMMARY

The presently disclosed technology describes a mechanical power supply system for electric motorcycles, comprising two electrical motors, an electrical motor A and an electrical motor B, and a battery pack; a transmission, connected to a gearbox and to a clutch through mechanical means, wherein each of the electrical motors, electrical motor A and electrical motor B, comprises independent bottom end shafts horizontally aligned and opposed; said each of the bottom end shafts comprises a primary transmission control pinion mechanically connected to the transmission.

In one of the proposed embodiments, the electrical motor A and the electrical motor B comprise the same power production output.

In another of the proposed embodiments, the electrical motor A comprises a superior power production output than the electrical motor B.

In another of the proposed embodiments, both primary transmission control pinion of each of the bottom end shafts comprise the same transmission ratio.

In another of the proposed embodiments, the primary transmission control pinion of the bottom end shafts of electrical motor A comprises a higher transmission ratio than the primary transmission control pinion of the bottom end shafts of electrical motor B.

In another of the proposed embodiments, the primary transmission control pinions of the bottom end shafts of electrical motor A and electrical motor B comprise epicycloidal gearboxes.

In another of the proposed embodiments, the mechanical power supply system comprises a software control system adapted to determine which of the electrical motor A or electrical motor B will operate, or both simultaneously.

In another of the proposed embodiments, the software control system comprises configuration and customization operating modes.

In another of the proposed embodiments, the mechanical power supply system comprises an additional internal charging motor adapted to recharge the battery pack when the system is in deceleration.

In another of the proposed embodiments, the electrical motor A or the electrical motor B is configured to operate as an energy regenerator to recharge the battery pack when the system is in deceleration.

In another of the proposed embodiments, the electrical motor A and the electrical motor B comprise liquid cooled brushless motors.

### General Description

The present application describes a mechanical power supply system for motorcycles resorting to the use of electrical motors. The proposed platform, based on a mechanical power supply system, is comprised of two electrical motors where each of the electrical motors are set with individual different or equal power. The combination of the operating the motors is performed either independently or in alternance, or jointly automatically or by manual selection of the operator, combining their power via synchronized electronic and/or gear system in order to propel a motorcycle or motor-vehicle. Part of the motorized platform is an integrated series of special gears and a dedicated shift to change gear and regulate speed and power being transmitted to the driving wheel either via belt, chain or crankshaft, therefore generating motion of the overall vehicle. The herein disclosed duo-flex compact electrical platform for motorcycles comprises an entire scalable platform with two motors, gears, and shift.

The platform layout comprises the two electric motors, with equal power production capability, or not as it is not mandatory, arranged in a way that each of the motor axis is arranged over the same matching horizontal plane, with both independent shaft ends being exactly aligned facing each other. The end of each shaft will comprise a primary pinion that will be connected to the main transmission that will provide the mechanical connection between the engine rotational movement and the gearbox.

There are several combinations for the platform arrangement, and the starting point might be considering, or not, the use of equivalent power production capabilities. In case of the motors are equally performant, the primary pinions connected to the transmission will have similar transmission ratios in order to distribute evenly the power produced by the two motors. The motors can work simultaneously, or alternately each of a time, depending on the power requirements of the user.

This combination and alternation of use between the motors, allows to, in case of need, obtain the overall power in a shorter time, when compared with solutions currently used, by activating the two motors, and when the need to use the full power is not a requirement, the platform allows to put one of the engines at rest, lowering the operating temperature of the block, minimizing the overall energy consumption of the engines in production, therefore extending the operational longevity of the block.

The operational management and respective performance of the motors is carried out by a software control system responsible for determining which of the engines will start operating and in which mode of operation, said modes being diverse and allowing for user customized configurations.

As previously mentioned, the platform also considers the use of engines with non-identical production capabilities. For this case, the ratios used for the primary pinions that interconnect with the transition are not the same. One of the engines will include a pinion with a smaller ratio in order to work dedicated to the economy mode, and the other engine will include a higher pinion ratio so that it is used in a dedicated manner to the sportive mode. In this case, as well as in the others, the transmission will be in charge of the combination and interleaving of the pinions and their placing into service according to the definitions of the control platform.

Still considering the use of motors where the balance of produced power is not equivalent, there is still the possibility of using epicycloidal gearboxes in the primary shafts of each motor. The ratio of this epicycloidal gears will be similar to the previously mentioned relation, where the smaller ratio is determined to work under the economy mode, and a higher ration oriented to work on the sport mode.

The proposed embodiments, with the use of different ratios allow to achieve a more accurate and defined response times enhancing the performance of the proposed platform.

The herein disclosed mechanical platform, allows to obtain greater battery autonomy, while optimising the converted electric energy in mechanical power through the use of a singular mechanical unit and specific gearbox ratios.

The optimization of the electrical system is achieved through a series of mechanical solutions that help to improve the overall autonomy of platform and provide a more defined range of speeds according to requirements. These mechanical solutions, of which the dual opposed electric motors make part, allow to adapt the output torque of the mechanical power supply system without the need to increase the electrical energy power consumption. Additionally, this mechanical arrangement allows to have one primary electric motor operating as a battery power recharger without overeating the secondary electric motor which is delivering the mechanical power to the gearbox.

The dual motor with the epicycloidal system allows to vary the mechanical power production ratio of each single motor, allowing therefore to vary independently the output power of each motor with the possibility of combining these two powers, and consequently increase output power, torque and speed.

The herein proposed kinematic mechanical power supply system allows to obtain an overall small platform in size, improving the layout of the platform, facilitating it's the positioning in the vehicle.

### BRIEF DESCRIPTION OF THE DRAWINGS

For better understanding of the present application, figures representing preferred embodiments are herein attached which, however, are not intended to limit the technique disclosed herein.

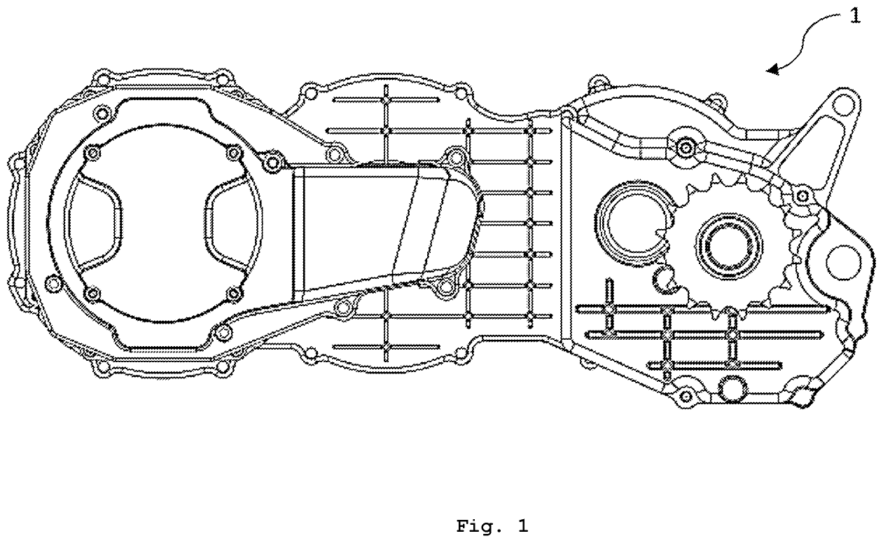

FIG. 1—discloses an illustration of the overall invention, in a side section cut perspective, where the reference numbers are related to:
1. duo-flex compact electrical platform for electric motorcycles/mechanical power supply system.

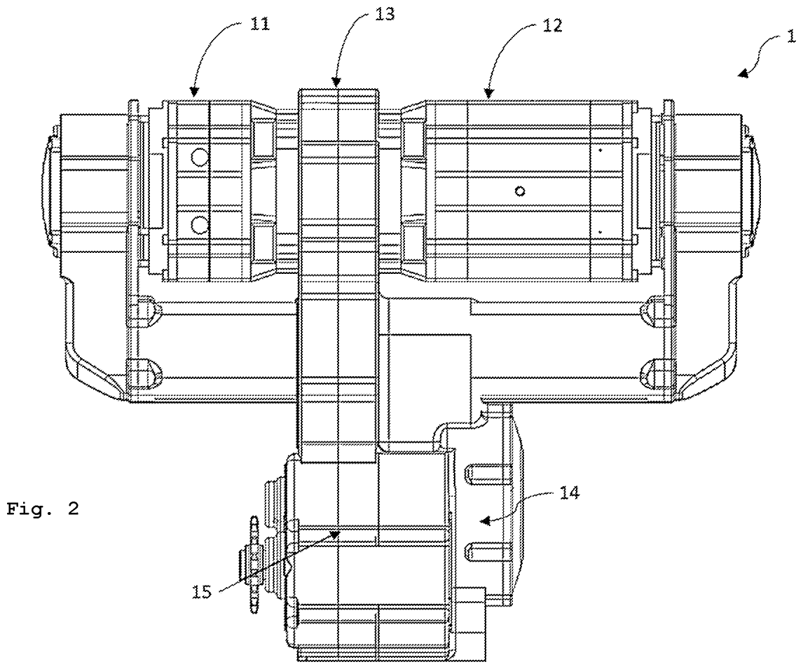

FIG. 2—represents the platform (1), in a upper view perspective, where the reference numbers are related to:
11—motor A;
12—motor B;
13—mechanical transmission;
14—hydraulic control clutch;
15—gearbox with shift and gears.

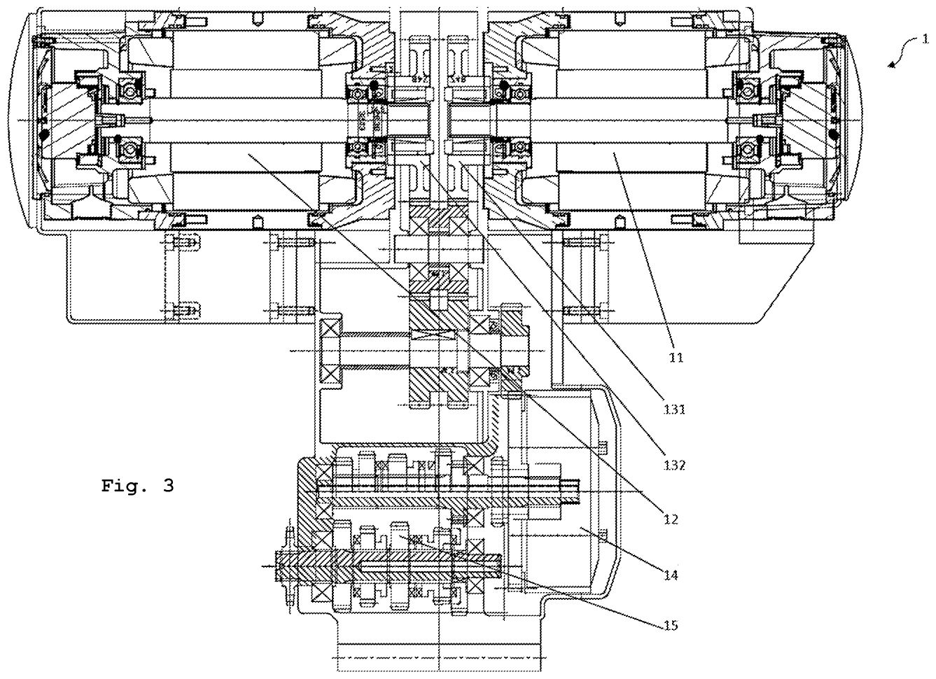

FIG. 3—represents one embodiment of the platform (1), in a horizontal cut upper view perspective, where the reference numbers are related to:
11—motor A;
12—motor B;
131—primary transmission control pinion on motor A;
132—primary transmission control pinion on motor B;
14—hydraulic control clutch;
15—gearbox with shift and gears.

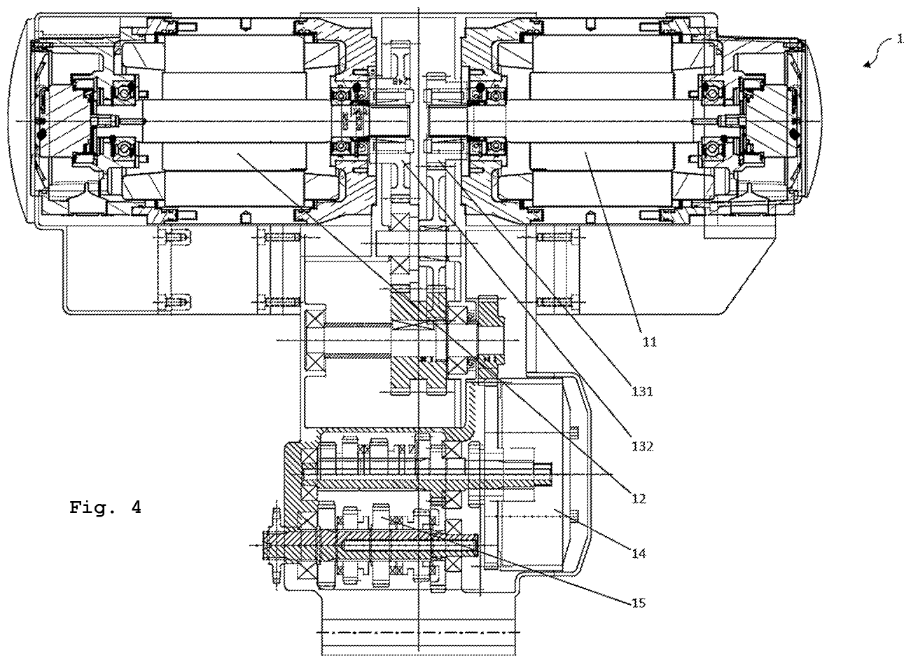

FIG. 4—represents other embodiment of the platform (1), in a horizontal cut upper view perspective, where the reference numbers are related to:
11—motor A;
12—motor B;
131—primary transmission control pinion on motor A;
132—primary transmission control pinion on motor B;
14—hydraulic control clutch;
15—gearbox with shift and gears.

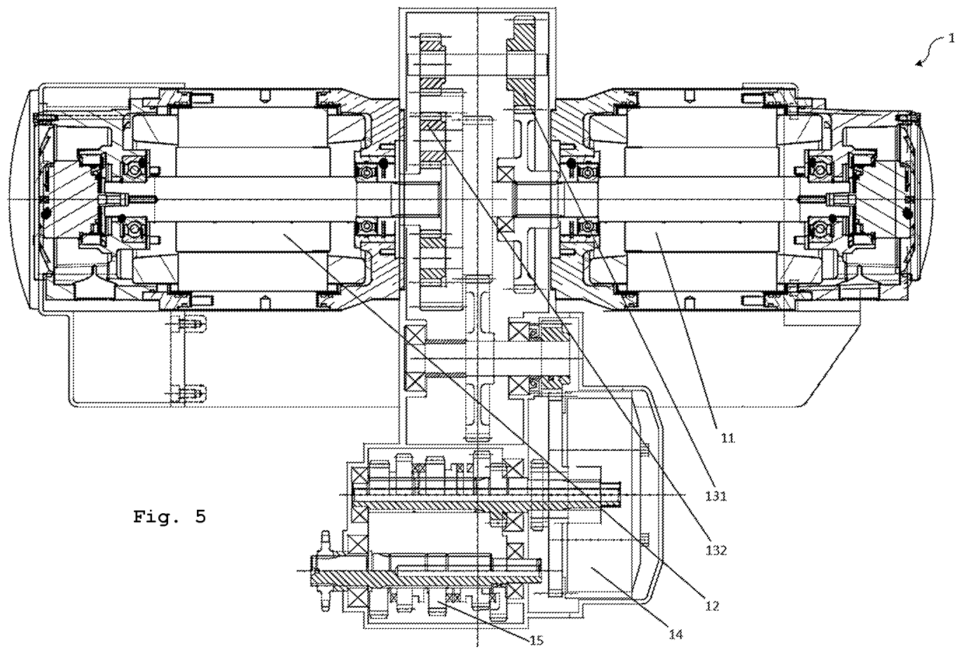

FIG. 5—represents other embodiment of the platform (1), in a horizontal cut upper view perspective, where the reference numbers are related to:
11—motor A;
12—motor B;
131—primary transmission control pinion on motor A;
132—primary transmission control pinion on motor B;
14—hydraulic control clutch;
15—gearbox with shift and gears.

### DESCRIPTION OF EMBODIMENTS

With reference to the figures, some embodiments are now described in more detail, which are however not intended to limit the scope of the present application.

The platform (1), or mechanical power supply system, in one of the preferred embodiments based on the disclosure of FIG. 3, comprises two motors, motor A (11) and motor B (12). Both motors (11, 12), in one of the preferred embodiments based on a liquid cooled brushless motors technology, comprise the same specs and same power production capacity, and have their axis arranged over the same matching horizontal plane, with both shaft ends being exactly aligned facing each other. Each shaft end of both motors (11, 12) comprises individual primary transmission control pinions (132, 132), with equivalent ratios, that through the mechanical internal gears of the transmission (13), will provide rotation movement to the gearbox (15). The electrical motors (11, 12) can operate individually in an ON-OFF arrangement, simultaneously, or synchronously coupled in a A-B motor model, with differentiated activation times according to the required output power needed. The transmission (13) is singular and comprises a unique ratio. With the proposed embodiment disclosed on FIG. 3, and comparing with similar electric engines, the platform (1) will allow to achieve lower energetic power consumption and better acceleration due to the half moment of inertia ensured by the mechanical gearbox (15). This platform (1) layout will include a charging motor for recharging the internal batteries when the platform (1) is in deceleration process. The use of liquid cooling on both electric motors (11, 112) allows to increase the stability and the durability of the platform (1), improving its performance and overall reliability over usage time.

In one of the proposed embodiments for present disclosure, one of the electrical motors (11 or 12), in an alternately manner, can be used as an energy regenerator, while the other motor is working providing power to the platform (1). With this self-recharging solution, it becomes possible to control the operating temperature of the overall platform (1) by always keeping one of the motors (11 or 12) with a low operating temperature since only one of the is really ensuring the mechanical power production.

Current arrangement also allows to achieve a more symmetrical platform (1), with balanced dimensions and weight distribution, leading to a lower center of gravity when the platform (1) is applied in a motorcycle structure. The use of the double motors (11, 12) with their central axis horizontally aligned and placed in a low position with regard to the overall platform, provide a more balanced power availability depending on the requirements and user request. As it is possible to see under the analysis of FIG. 2, the T shaped platform (1) enables a uniform weight distribution on the motorcycle frame, where both motors (11, 12) are placed along with a central positioning of the transmission (13), supported by the clutch (14) and gearbox (15) that will provide the rotational transmission to the wheels, helping the platform (1) lowering the power absorption. FIG. 1 is also very exemplary on the compactness of the suggested platform (1) that leads to the referred balanced weight distribution.

With the proposed mechanical arrangement platform (1) applied to a vehicle, it is possible to improve its overall performance with lower and optimized electrical power consumption which will lead to greater autonomy, and consequently, lower power requirement for the battery pack, leading to reducing the overall weight of the motorcycle.

The motor platform (1) is managed and controlled by a software system configured to operate accordingly to five calibration levels, or modes, comprising ECONOMY, SPORT, RAIN, NORMAL and a customized configuration. The software system will start by default with one operating motor (11), level one setting, and depending on the second selected setting, the platform (1) will intervene, more or less quickly, with the introduction of the second motor (12). Independently of the driving setting, the software will always know in what gear the gearbox (15) of the platform (1) is working on, so it can manage and define the power and acceleration to be applied in each gear. The software system is also responsible for the management of the battery charging procedures, determining the charge available capacity and any associated failures.

On other possible arrangement of the platform (1), the motors A and B (11, 12) are not equivalent in terms of power production capability. This arrangement is disclosed on FIG. 4, and besides the differentiating characteristics, the primary transmission control pinion (131) of motor A (11), in this layout, comprises a shorter ratio to operate in an ECONOMY mode with free wheel. On the other way, the primary transmission control pinion (132) of motor B (12) comprises an extended ratio to operate in SPORT mode. On this proposed embodiment of platform (1), the two brushless motors A (11) and B (12), different in power production capability, resort to a primary transmission (13) with two different ratios (131, 132) to enhance the mechanical features of the ECONOMY and SPORT modes.

With this layout, the platform (1) will allow to lower the electric power consumption, increasing acceleration due to the mechanical gearbox (15) with different ratios. As on previous suggested layout, this platform (1) will also include a self-charging motor capability to recharge the internal batteries when the platform (1) is in deceleration process. The use of liquid cooling on both motors allows to increase the stability and the durability of the platform (1), improving performance and overall reliability over usage time.

On another possible arrangement of the platform (1), pictured on FIG. 5, motors A and B (11, 12) are still not equivalent in terms of power production capability. However, on this proposed layout, the primary transmission control pinion (131) comprises an epicycloidal gearbox to operate in the ECONOMY mode. Similarly, the primary transmission control pinion (132) of motor B (12) comprises an epicycloidal gearbox to operate in SPORT mode. When compared with the previous solution, the use of epicycloidal gearboxes in the primary transmissions (131, 132) group allows obtain differentiated ratios that can operate jointly with the sum or difference of the speeds of the relative reductions to better enhance the ECONOMY and SPORT operating modes.

Although the invention has been explained in relation to its preferred embodiment, it is to be understood that many other possible modifications and variations can be made without departing from the spirit and scope of the invention.

1. A mechanical power supply system (1) for electric motorcycles, comprising:
an electrical motor A (11) and an electrical motor B (12), and a battery pack;
a single transmission (13), connected to both the electrical motor A (11) and the electrical motor B (12), the single transmission (13) connected to a gearbox (15) and to a clutch (14) through mechanical means,
wherein each of the electrical motor A (11) and the electrical motor B (12), comprises independent bottom end shafts, and
wherein each of the bottom end shafts comprises a primary transmission control pinion (131, 132), the primary transmission control pinions are mechanically connected to the single transmission (13).

2. The mechanical power supply system (1) according to claim 1, wherein the electrical motor A (11) and the electrical motor B (12) comprise the same power production output.

3. The mechanical power supply system (1) according to claim 1, wherein the electrical motor A (11) comprises superior power production output than the electrical motor B (12).

4. The mechanical power supply system (1) according claim 1, wherein both primary transmission control pinion (131, 132) of each of the bottom end shafts comprise the same transmission ratio.

5. The mechanical power supply system (1) according to claim 1, wherein the primary transmission control pinion (131) of the bottom end shafts of electrical motor A (11) comprises a higher transmission ratio than the primary transmission control pinion (132) of the bottom end shafts of electrical motor B (12).

6. The mechanical power supply system (1) according to claim 1, wherein the primary transmission control pinions (131, 132) of the bottom end shafts of electrical motor A (11) and electrical motor B (12) comprise epicycloidal gearboxes.

7. The mechanical power supply system (1) according to claim 1, further comprising a software control system adapted to determine which of the electrical motor A (11) or electrical motor B (12) will operate, or both simultaneously.

8. The mechanical power supply system (1) according to claim 7, wherein the software control system comprises configuration and customization operating modes.

9. The mechanical power supply system (1) according to claim 1, further comprising an additional internal charging motor adapted to recharge the battery pack when the system (1) is in deceleration.

10. The mechanical power supply system (1) according to claim 1, wherein the electrical motor A (11) or the electrical motor B (12) is configured to operate as an energy regenerator to recharge the battery pack when the system (1) is in deceleration.

11. The mechanical power supply system (1) according to claim 1, wherein the electrical motor A (11) and the electrical motor B (12) comprise liquid cooled brushless motors.
